(19) United States
(12) Patent Application Publication
(10) Pub. No.: US 2009/0182628 A1
(43) Pub. Date: Jul. 16, 2009

(54) Limited brand GPS mobile device, method and system

(76) Inventor: Michael Chechelniker, Brooklyn, NY (US)

Correspondence Address: Michael Chechelniker, 3178 Nostrand ave. #5K, Brooklyn, NY, 11229, US

(21) Appl. No.: 11/555,423

(22) Filed: Nov. 1, 2006

Related U.S. Application Data
(62) Division of application No. 60/596,954, filed on Nov. 1, 2005.

(51) Int. Cl. G06Q 30/00

(52) U.S. Cl. 705/14

(57) ABSTRACT

Invention is subsidized Limited brand GPS mobile device, method and system that allows consumers to obtain the GPS device at subsidized low cost or even free, wherein consumers pay for individual destinations on-demand, package of on-demand destinations, or use free destinations featured on the device of sponsoring companies brands and other free non-profit destinations featured on the devices. Free non-profit destinations include Police, Parks, Hospitals, Airports, and other such destinations given to consumers free. Free destinations of Sponsoring Companies include destinations of franchises, gas stations, retail and other brand name companies who subsidize the device cost by being the only destinations feature in specific point of interest categories. Exclusive featuring of certain categories is possible for sponsoring companies. Sponsoring companies by subsidizing the initial device cost, distribution and support loose money in the beginning but gain brand recognition from the consumers. Sponsoring Companies also regain the loss by providing services to device owners available for purchase. Since device is capable to display and incorporate information goods for the use on the device by consumers, content such as images, video, music, ebooks, audio books, games, stock quotes, email, web and advertisement content.

This application claims the benefit of U.S. Provisional Application No. 60/596,954, filed Nov. 1, 2005, by Michael Chechelniker, entitled “BRAND NAME GPS”, the entire contents of which are incorporated herein by reference.

### FIELD OF THE INVENTION

Invention relates to a system, method, and device of using limit capable product for brand name promotion and recognition, and specifically to a subsidized GPS system device with brand name incorporation.

### BACKGROUND OF THE INVENTION

GPS devices are common today but they all follow distribution to consumers via retail outlets. These devices feature full package of destinations including data base of addresses, and point of interest that are fully accessible for use.

Such GPS devices have substantial cost to consumers, but are rarely used to their potential.

### SUMMARY OF THE INVENTION

The following invention allows consumers to obtain the GPS device at subsidized low cost or even free, wherein consumers pay for individual destinations on-demand, package of on-demand destinations, or use free destinations featured on the device of sponsoring companies brands and other free non-profit destinations featured on the devices.

Free non-profit destinations include Police, Parks, Hospitals, Airports, and other such destinations given to consumers free. Free destinations of Sponsoring Companies include destinations of franchises, gas stations, retail and other brand name companies who subsidize the device cost by being the only destinations feature in specific point of interest categories. Exclusive featuring of certain categories is possible for sponsoring companies.

Sponsoring companies by subsidizing the initial device cost, distribution and support loose money in the beginning but gain brand recognition from the consumers. Sponsoring Companies also regain the loss by providing services to device owners available for purchase. Since device is capable to display and incorporate information goods for the use on the device by consumers, content such as images, video, music, ebooks, audio books, games, stock quotes, email, web and advertisement content.

### BRIEF DESCRIPTION OF THE SEVERAL VIEWS OF THE DRAWING

FIG. 1 illustrates the invention as a variation corresponding to symbol M embodiment of Limited brand GPS mobile device.

### DETAILED DESCRIPTION OF THE INVENTION

Invention comprises of limited capable stand alone GPS device, Limited brand GPS mobile device, which has ability to pinpoint geographic location of GPS accordingly, however, has only ability to portray destinations of a limited ability. Such limited destinations are a specific brand name, a company, a group of destinations, or any other entity that sponsors a product. Such entities usually have retail, franchise or other locations in various geographic destinations are most efficient to implement the invention.

Invention comprises of software or hardware method of implementation of the system model into GPS device. Software protection is software limited destination input or display. This method can be used in combination with other destinations, such as police stations, hospitals, hotels or other destination display features that sponsoring brand provides, such as affiliate, partners and other. Hardware encoded device provides better protection that the device will have limited capabilities, meaning it can not be flashed by a software programmer, or hacker for unauthorized use. The security method for protecting device can be of such and other means, and outsourced to GPS device manufacturing company.

Method of display of destination used in according to standard GPS functions such as: displaying the closes destination, selecting specific destination, and other functions and feature of selecting destinations. Presented device, however, may be limited in such choices.

In one possible business method of marketing Limited brand GPS mobile device, sweepstakes business method is incorporated. Limited brand GPS mobile device sponsoring entity advertises sweepstakes giveaway, marketing games and other means for distributing limited number of devices for free, or with purchase of other product or service.

In another possible business method of marketing, device is sold at reduced prices that are lower then market price of full featured device, purely for brand name recognition and advertisement purposes.

In one method of invention, one of destinations can be set as a home location by the user. This would allow users to return home by knowing the closest geographical location of a distributor and setting it as a home destination. Thus one button press on a GPS device will reroute a GPS guided route to that location. This feature also helps in consumer recognition of a geographical location of a sponsoring brand outlet.

The main benefit of a brand name distributor of such device would be brand recognition, advertisement and marketing. By selling at discounted prices, sweepstakes or other distribution methods of such device even at no profit or a loss, company whose brand is featured on a device gains not only name recognition every time user uses a device, but also a physical location recognition by users.

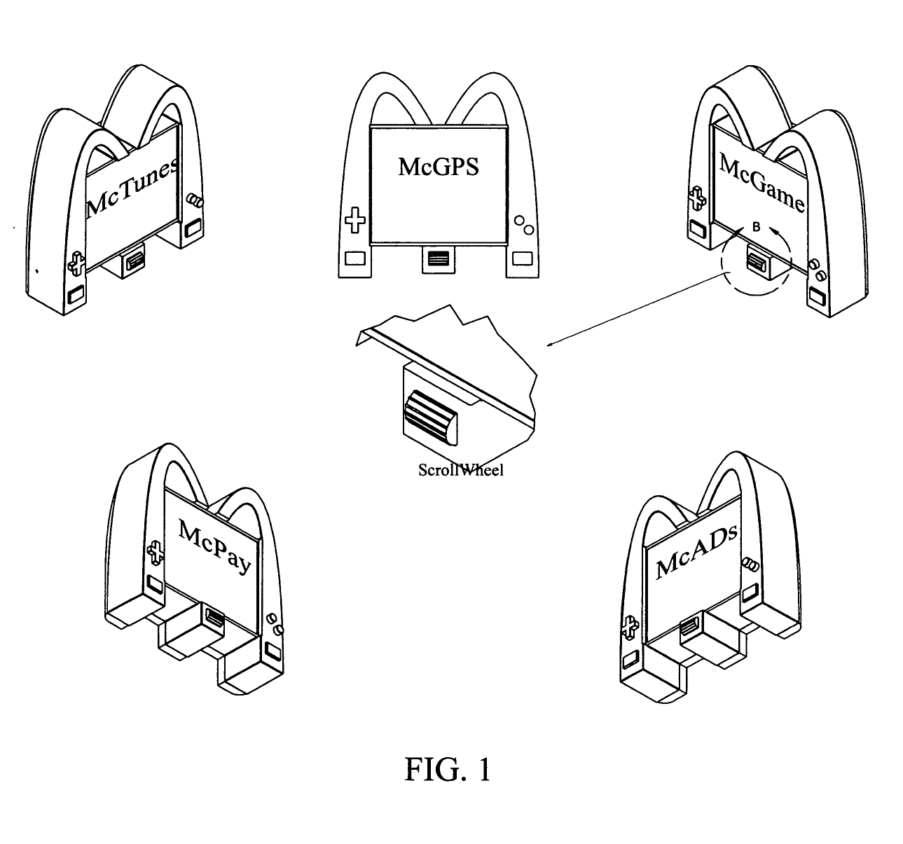

The invention, when used as stand alone GPS device, can be embedded in a corporate logo enclosure of various designs. Thus, for examples device distributed by McDonalds Corporation could have a big letter ‘M’ enclosure with a display in the middle, as shown in FIG. 1. This feature provides for further brand recognition. The security method of disablement if detaching enclosure is implemented and could be of any means. It provides a confidence that device would not be hacked to strip it of brand image and features, or reuse components for any other unauthorized use.

Invention is used by a Primary Sponsoring Company as a promotional vehicle of initial market penetration. Example of incorporating the invention with marketing campaign in example with McDonalds Corporation results, “did somebody say McDonalds?” to become: “were to? . . . did somebody day McDonalds?”

Invention comprises incorporating Primary Sponsoring Company's recognizable image to relate to invention and expand into service providing field of information product content distribution, wherein contents are distributed by the invented method into the invented Limited brand GPS mobile device. In example of McDonalds Corporation, content and content service names are merged with recognizable brand image to result in, “McTunes” for music content, “McGames” form game content, “McBooks” for electronic book content, “McAds” for advertisement content, “McVideo” for video content, “McPay” for pay services, and “McGPS” for the device presented in invention itself, as shown in FIG. 1. Other service related names are, “McShop”, “McPOI”, “McAdress”, etc.

In one variation of invention, Primary Sponsoring Company and other Sponsoring Companies are in partnership for subsidized distribution of the device. The intent of such partnership in subsidized distribution is to create a user base of device owners that will further start purchasing content by the invented method and system. To further cover the initial cost of device, distribution and support, brand recognition plays substantial role. Since only the Sponsoring Companies are features on the device, consumers who own the device will drive additional traffic to local locations of such Brands. Consumers are also likely recognize the brand more, if logo or only such brand is feature on the device. For Primary Sponsoring Company, marketing campaign is oriented around the device. In example with McDonalds Corporation, the whole TV, Print and other advertising campaign is set to revolve around the device with a main message: “Anywhere you go, McDonalds will take you there”, or simply “Anywhere you go. McDonalds”.

Primary Sponsoring Company initial investment far outweighs other Sponsoring Company's one. Primary Sponsoring Company, however, is the only Company whose destinations are featured in a Major Category of Points of Interest. This category is hierarchal one of the few categories in the first screen of User Interface. In example with McDonalds, the whole food, diner and restaurant category has only the destinations of McDonalds locations. So User Interface of initial screen has “Home” destination category, McDonalds destination category, Point of Interest destination category, address destination category and other feature first level destinations category as is currently present in modern GPS devices.

Address destinations can be bought as paid-for single destinations, wherein customer logs in to his account with Primary Sponsoring Company or other Service Providing Company that is licensed to sell single destinations for a certain fee, or provide a scheme to obtain such destinations free. The latter could be ad-supported destinations where consumers watch advertisement content, location supported continuous destinations where consumers must first attend a certain location of Sponsoring Company, or other scheme.

A method of updating device is incorporated into invention to provide updated locations. Device could be plugged in to computer and updated via internet. The security for such optional feature should be of the highest level, so not to allow for unauthorized use of device.

A software model of invention is also present in this application. Software model would be similar to description above, but would use software only features, such as brand only destinations, and brand only home destination of a closest location as preferred.

In another application of invention, business method for incorporating brand name into consumer products or services and distribution at discounted price, sweepstakes, giveaways or any other methods is described. Usually products sufficient for such method are the ones that would allow maximizing the brand exposure with minimized risk of being unauthorized in use. The example of such consumer products are software with brand name buttons and logos, banners incorporated into application or other means. Software that allows children to learn math by counting potato fries, or measuring their length, could be one of examples of such method if distributed by fast-food Restaurant Company. The physical consumer good of similar example could be counting sticks of brand name French-fries.

Service Proving Companies provide information goods to Limited brand GPS mobile device users. Such content comprises images, video, music, ebooks, audio books, games, stock quotes, email, web and advertisement content. Service Companies distribute their content via internet and electronic catalogs that gets accessed by the device from any location capable of proving connection supported by device. Invented device supports Wi-Fi wireless connection standard or any other current internet connection standard.

Primary Sponsoring Company in one variation is Service Providing Company. Users of invented device create an account that is loaded with funds by credit card or other method. When content is distributed to the device, account gets charged with a certain amount.

Limited brand GPS mobile device has hardware and software identification system imbedded into the device. Identification system is linked to account system and is unique to each individual Limited brand GPS mobile device. Sponsoring Companies utilize the identification system linked to the account system to distributed location oriented services to device owners by charging the funds from the account. Services such as retail, gas station, self-checkout services, drive through services and other services utilize this feature.

Advertisement content is distributed via Advertisement Service Providing Companies. Such company is internet based company. In the method and system of the invention, local businesses and entities interested to advertise their local interest, create account with Advertisement Service Providing Company and specify the advertisement specifics. This advertisement content is delivered to device at locations of Sponsoring Companies or other locations. GPS current location of the device is reported to Advertisement Service Providing Companies that sends ads of interest to the device according to that current location.

Limited brand GPS mobile device comes with all the destinations data of fully capable GPS stand alone device loaded onto the device. This data is locked and not displayed on the device initially. Only destinations of unlocked type such as free-paid-for destinations provided by sponsoring companies, free non-profit destinations, free home destination is shown on the device. Locked destinations become unlocked pre-paid destination package, paid-for single destinations, ad-supported destinations, location supported continuous destinations when purchased or followed the method of obtaining such destinations for free as described in invention.

What is claimed is:

1. Limited brand GPS mobile device comprising:
unlocked destinations including free-paid-for destinations provided by sponsoring companies, free non-profit destinations, free home destination;
locked address destinations and locked point of interest destinations;
pre-paid destination package, paid-for single destinations, ad-supported destinations, location supported continuous destinations.

2. Limited brand GPS mobile device of claim 1, wherein sponsoring companies comprise franchise restaurant companies, gas station brands, retailers and other brands with local representation.

3. Limited brand GPS mobile device of claim 1, wherein sponsoring companies are brand name companies in partnership of subsidizing the cost of the device.

4. Limited brand GPS mobile device of claim 1, wherein destinations are selected by user.

5. Limited brand GPS mobile device of claim 1, wherein destinations are selected via user interface system of the device.

6. Limited brand GPS mobile device of claim 1, wherein destinations are geographical locations programmed into device.

7. Limited brand GPS mobile device of claim 1, wherein free-paid-for destinations provided by sponsoring companies are destinations of specific locations of such companies that are revealed on the device.

8. Limited brand GPS mobile device of claim 1, wherein free-paid-for destinations provided by sponsoring companies comprise brand name logo of the participating companies.

9. Limited brand GPS mobile device of claim 1, wherein free non-profit destinations of other interest include Police, Parks, Hospitals, Airports and other unlocked destinations featured on the device free that are revealed.

10. Limited brand GPS mobile device of claim 1, wherein free home destination is a destination and stand alone category that is given to consumers free.

11. Limited brand GPS mobile device of claim 1, wherein locked destinations comprise all geographical locations corresponding to destinations that are hidden by the software from being displayed.

12. Limited brand GPS mobile device of claim 1, wherein locked destinations are physically present on the device.

13. Limited brand GPS mobile device of claim 1, wherein locked destinations comprise initially destinations other then destinations then free-paid-for, free non-profit and free home destinations.

14. Limited brand GPS mobile device of claim 1, wherein locked destinations are destinations hidden from display by the software.

15. Limited brand GPS mobile device of claim 1, wherein locked destinations are destinations unlocked when purchased.

16. Limited brand GPS mobile device of claim 1, wherein pre-paid destinations are unlocked destinations purchased by consumers in packages such as New York state package, or other groups of various destination types.

17. Limited brand GPS mobile device of claim 1, wherein paid-for single destinations are unlocked destinations that have been purchased.

18. Limited brand GPS mobile device of claim 1, wherein location supported continuous destinations are destinations that are revealed when presented GPS device enters a location of sponsoring company.

19. Limited brand GPS mobile device of claim 1, wherein ad-supported destinations are destinations that are revealed when advertisement is seen.

20. Method of distribution and subsidization of cost of the Limited brand GPS device by the sponsoring companies and primary sponsoring company, wherein only the sponsoring companies get their brand destinations featured on the device within certain categories.

21. Method of the claim 20, wherein certain categories comprise restaurants, gas stations, retail shopping, hotels, coffee shops.

22. Method of the claim 20, wherein certain categories comprise other categories featured on GPS device.

23. Method of the claim 20, wherein certain categories comprise sub categories of point of interest often featured on GPS devices.

24. Method of the claim 20, wherein more than one sponsoring company is featured in a certain category.

25. Method of the claim 20, wherein a sponsoring company is exclusively featured in a certain category.

26. Method of the claim 20, wherein subsidization of cost is collective effort of sponsoring companies to invest in brand name recognition of company's locations featured on Limited brand GPS device in form of destinations.

27. Method of the claim 26, wherein destinations comprise free-paid-for destinations of claim 1.

28. Method of the claim 20, wherein distribution is achieved by primary sponsoring company.

29. Method of the claim 20, wherein primary sponsoring company is Franchise Company.

30. Method of the claim 20, wherein primary sponsoring company comprises distributing the device by marketing campaign.

31. Method of the claim 20, wherein primary sponsoring company is featured as an enclosure of the device.

32. Method of the claim 31, wherein enclosure is an enclosure that resembles primary sponsoring company's logo.

33. Method of the claim 31, wherein enclosure is an enclosure that resembles primary sponsoring company's recognizable public image.

34. Method of the claim 31, wherein enclosure is resemblance of letter M that has display in the middle.

35. Method of the claim 31, wherein enclosure is fit with inside components that are placed to fill the volume to protect the enclosure from being removed.

36. Method of the claim 20, wherein brand destinations comprise sponsoring companies logos.

37. Method of the claim 20, wherein subsidizations is achieved by a collective effort of sponsoring companies.

38. Method of the claim 20, wherein primary company comprises exclusively featured category on the device main screen.

39. Method of the claim 20, wherein primary company comprises highest level of hierarchical display category on the device.

40. System of service distribution and capabilities of the Limited brand GPS mobile device to incorporate such services into information goods that are obtained from service providing companies via wireless or wired connection supported by the device at any location capable of such connection; system that is secured by identification feature that is unique to each individual device.

41. System of claim 40, wherein information good includes images, video, music, ebooks, audio books, games, stock quotes, email, and web content.

42. System of claim 40, wherein information goods include advertisement content.

43. A System of claim 42, wherein advertisement content is linked to the current GPS location of the device.

44. System of claim 40, wherein information goods include shopping catalog.

45. System of claim 40, wherein information goods include paid-for single GPS destinations of claim 1.

46. System of claim 40, wherein system further comprises ability to integrate other services and content via creation of single software platform.

47. System of claim 40, wherein information good that is obtained from service providing companies comprises purchasing content from such service providers and downloading content to the device.

48. System of claim 40, wherein wireless or wired connection supported by the device is internet connection.

49. System of claim 40, wherein wireless connection supported by the device is Wi-Fi connection.

50. System of claim 40, wherein wireless connection supported by the device is any wireless connection platform or standard.

51. System of claim 40, wherein system further comprises device to device communication system.

52. System of claim 51, wherein device to device communication system comprises connection via internet.

53. System of claim 51, wherein device to device communication system comprises direct connection to another device.

54. System of claim 51, wherein device to device communication system includes voice, video, and text communications.

55. System of claim 51, wherein device to device communication system includes exchange of data.

56. System of claim 40, wherein identification feature comprises unique hardware feature to each individual device that is recognized via wireless connection to the device and identifies each individual device as unique to the other.

57. System of claim 40, wherein identification feature comprises individual account system.

58. System of claim 57, wherein individual account system comprises a user account created with service providing companies.

59. System of claim 57, wherein individual account system comprises a user account created with sponsoring companies.

60. System of claim 57, wherein individual account system comprises a user account created with primary sponsoring company.

61. System of claim 57, wherein identification feature is directly linked to individual account system.

62. System of claim 57, wherein individual account system comprises loading of monetary funds into a user account.

63. System of claim 57, wherein individual account system comprises loading of monetary funds into a user account with primary company.

64. System of claim 57, wherein individual account system comprises making monetary transactions with service providing companies.

65. System of claim 57, wherein individual account system comprises making monetary transactions with sponsoring companies.

66. System of claim 57, wherein individual account system comprises making monetary transactions with primary sponsoring company.
